(19) United States
(12) Patent Application Publication
(10) Pub. No.: US 2003/0206662 A1
(43) Pub. Date: Nov. 6, 2003

(54) Method and apparatus for improving perceived digital image quality

(76) Inventors: Gopal B. Avinash, New Berlin, WI (US); Kenneth S. Kump, Waukesha, WI (US)

Correspondence Address: Patrick S. Yoder, Fletcher, Yoder & Van Someren, P.O. Box 692289, Houston, TX, 77269-2289, US

(21) Appl. No.: 10/138,549

(22) Filed: May 3, 2002

(51) Int. Cl. G06T 5/00; G06T 3/40

(52) U.S. Cl. 382/254; 382/300

(57) ABSTRACT

A method and apparatus are provided which improve the perceived quality of a digital image by introducing high frequency noise into the image. In particular, the product of random numbers and a weighting factor determined by the characteristics of the image to be modified are used to generate weighted noise image. When the weighted noise image is added to the image to be modified, the combined image is perceived as having improved image quality.

### BACKGROUND OF THE INVENTION

The present invention relates generally to the field of digital image processing. In particular, the present invention is related to the improvement of perceived image quality involved in the processing or resealing of digital images.

Digital imaging systems and digital images have become prevalent in many fields where analog techniques and images, printed or otherwise, were previously the standard. Digital imaging systems offer several advantages including the ease with which digital images may be captured, processed, stored, and transmitted when compared to traditional analog techniques. Examples of the prevalence of such systems abound in the graphics and multimedia fields, consumer electronics, telecommunications, as well as the science and engineering fields. The medical field as well has adopted digital imaging systems, replacing such techniques such as traditional film X-ray with digital X-ray systems.

In the process of transitioning from film or analog techniques to digital techniques, there are often perceived differences between the old analog images and the newer digital images. These differences may be attributable to different pixel size, color blending, or artifact types. Nevertheless, users who are familiar with the images produced by the older analog techniques often perceive the digital images as being of lower quality based upon these differences.

One factor contributing to the perception of poor quality of images is typically the difference between the pixel pitch of the acquiring device and the associated pixel pitch of the output device. An example of this phenomena is observed in the context of digital X-ray systems. In such systems, the pixel pitch associated with an acquired digital X-ray image may be on the order of 200 μm while the respective output pixel pitch associated with a laser film printer or similar output device may be on the order of 86 μm. The larger pixel size of the acquired image causes the image to appear clumpy when output, creating the perception of inferior image quality in comparison to prior, analog systems. Likewise, the acquired image may be output to a display device that has a larger pixel size than the acquiring device, such as a monitor which has a typical pixel pitch on the order of 236 μm. In such circumstances, the different pixel sizes associated with the acquiring and the output devices may also create a perception of poor image quality relative to prior techniques. Similar quality perception problems exist in other fields, such as print photography, where users are accustomed to certain pixel pitches in the output image and may be unsatisfied with the perceived quality of digital images acquired by devices with a different pixel pitch than the respective output devices.

One solution to this problem is to rescale an acquired image, typically by either bilinear or bicubic interpolation, prior to either printing or displaying the image so that the pixel pitch of the output image is appropriate for the output device. The interpolation, however, does not sufficiently address the problems associated with noise since the grain of the noise pixels, when interpolated, is not as fine as that seen in analog images. Instead the interpolation process allows the pixel noise to be spread out among adjacent pixels. Thus interpolation, though generating a digital pixel pitch equivalent to that of analog images, fails to produce an equivalent perception of quality in the digital image, and again may provide “clumpy” images.

There is a need, therefore, for an improved technique for processing digital images. To address the drawbacks in heretofore known systems, there is a particular need for a technique which can be employed in a straightforward manner to improve the perceived quality of digital images such that the users familiar with analog images perceive the digital image as being of the same or of comparable quality.

### BRIEF DESCRIPTION OF THE INVENTION

The present invention provides for the introduction of weighted amounts of random noise into the interpolated image on a pixel-by-pixel basis. The amount of weighting may be established by trial and error but will generally be intensity dependent. The weighted random noise produces an image or mask which is then added to the interpolated image to yield an output image which may be printed or displayed.

The addition of fractional amounts of weighted noise introduces high frequencies to the interpolated image. The addition of these high frequencies imparts the perception of a texture to the digital image which is equivalent to that seen in analog images. The digital image quality is therefore perceived to be equivalent to that of an equivalent analog image.

In accordance with one aspect of the present invention, a method is provided for improving the appearance of a digital image by constructing a weighted noise image of the same dimensions such that each pixel of the weighted noise image is the product of a weighting factor and a random number. The weighted noise image is then combined with the digital image.

Likewise, in accordance with another aspect of the present invention, a method is provided for improving the appearance of a digital image by constructing an intensity dependent noise image. Each pixel of the intensity dependent image is the product of an intensity dependent weighting factor, determined by the intensity of a respective pixel in the digital image, and of a random number drawn from a uniformly distributed population. The intensity dependent noise image is then combined with the digital image.

An image processing system is provided in accordance with another aspect of the present invention. The image processing system includes digital imaging circuitry capable of generating a digital image and image processing circuitry which can receive and rescale the digital image. The image processing circuitry also generates a weighted noise image based upon some pixel characteristics of the rescaled image and upon a series of random numbers. The image processing circuit then combines the weighted noise image and the rescaled image to form an output image.

An image processing system is provided in accordance with another aspect of the present invention. The image processing system includes digital imaging circuitry capable of generating a digital image and image processing circuitry which can receive and rescale the digital image. The image processing circuitry also generates an intensity dependent noise image based upon the pixel intensity of the rescaled image and upon a uniformly distributed series of random numbers. The image processing circuit then combines the intensity dependent noise image and the rescaled image to form an output image.

An image processing circuit capable of receiving a digital image is provided in accordance with another aspect of the present invention. The image processing circuit includes circuits which generate a weighted noise image of the same dimensions as the digital image where each pixel of the weighted noise image is the product of a weighting factor and a random number. The image processing circuit then combines the weighted noise image and the digital image.

An image processing circuit capable of receiving a digital image is provided in accordance with another aspect of the present invention. The image processing circuit includes circuits which generate an intensity dependent noise image of the same dimensions as the digital image, where each pixel of the intensity dependent noise image is the product of a weighting factor, determined by the intensity of the respective pixel in the digital image, and a random number from a uniformly distributed population of random numbers. The image processing circuit then combines the intensity dependent noise image and the digital image.

An image processing system is provided in accordance with another aspect of the present invention. The image processing system includes digital imaging circuitry capable of generating a digital image and image processing circuitry which can rescale the digital image. The image processing circuitry also possesses means for generating a weighted noise image which is subsequently combined with the rescaled image to form an output image.

An image processing circuit capable of receiving a digital image is provided in accordance with another aspect of the present invention. The image processing circuit possesses means for generating a weighted noise image and also possesses one or more circuits for combining the weighted noise image and the digital image.

### BRIEF DESCRIPTION OF THE DRAWINGS

The foregoing and other advantages and features of the invention will become apparent upon reading the following detailed description and upon reference to the drawings in which:

FIG. 1 is a diagrammatical representation of a digital imaging system implementing certain aspects of the present processing technique;

FIG. 2 is a flowchart illustrating the processing of a digital image according to the present processing technique; and

FIG. 3 is a flowchart illustrating an alternative processing of a digital image according to the present processing technique.

### DETAILED DESCRIPTION OF SPECIFIC EMBODIMENTS

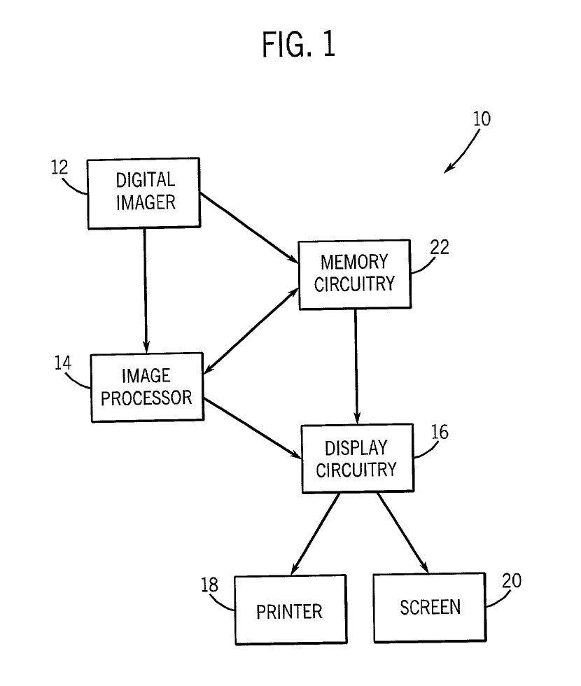

Turning now to the drawings, and referring first to FIG. 1, a digital imaging system 10 is illustrated diagrammatically as including digital imaging circuitry 12, image processing circuitry 14, display circuitry 16 and memory circuitry 22. The digital imaging system 10 may include any suitable digital imaging circuitry 12, including a flatbed scanner, digital camera, or digital detector. In one embodiment of the invention the digital imaging circuitry 12 may be a digital detector of the type commonly used in digital X-ray systems.

A digital image is typically acquired by the digital imaging circuitry 12 which relays the image to the image processing circuitry 14. The image processing circuitry 14 may perform various manipulations of the image such as adjusting brightness or contrast or providing color correction, contour or edge sharpening, noise reduction or other procedures. In the present technique, the image processing circuitry 14 also rescales the image using interpolation techniques as discussed below. The image processing circuitry 14 produces an output image as a result of the present technique which is relayed to the display circuitry 16. The display circuitry 16 is configured to receive the output image and, using the appropriate drivers or modules, to display the output image upon an available medium. In FIG. 1, the display circuitry 16 is depicted as displaying the output image on either a printer 18, such as a film, inkjet, or laser printer, or a monitor 20.

Alternately, the digital imaging circuitry 12 may relay the acquired image to the memory circuitry 22 from which the image processing circuitry 14 may retrieve the image. Additionally, the image processing circuitry 14 may send the processed image to the memory circuitry 22, allowing the display circuitry 16 to retrieve the image from the memory circuitry 22. The memory circuitry 22 may comprise any combination of volatile or non-volatile memory elements and, as one skilled in the art would appreciate, may allow the temporary or long term storage of pre-processed or processed images for subsequent use. For purposes of simplicity, the operation of the memory circuitry 22 will be assumed to be transparent to both the operator and to the other components of the digital imaging system 10 in the following discussion.

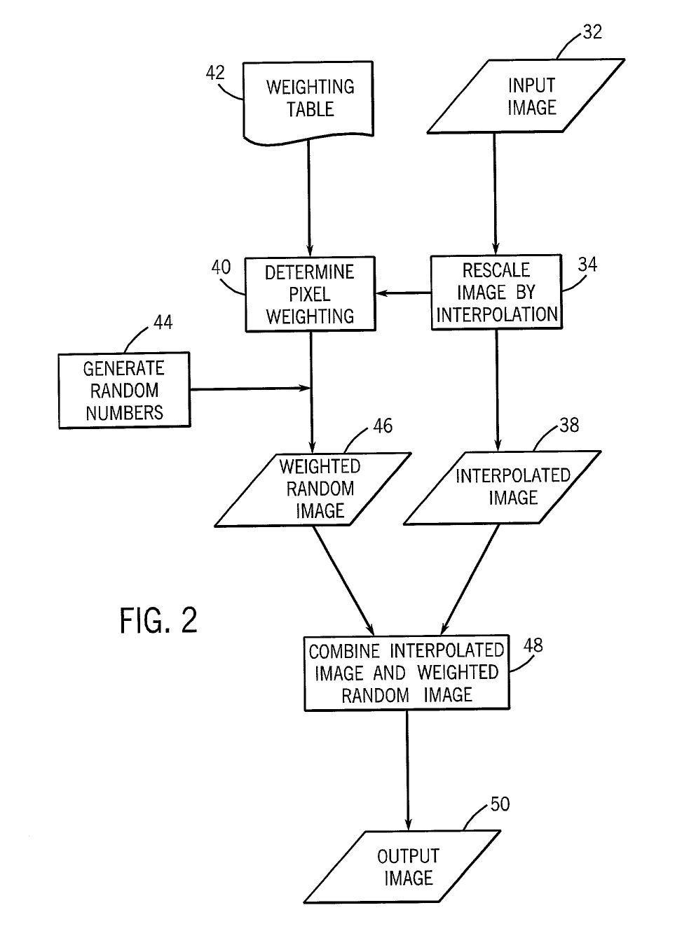

Referring now to FIG. 2, a flow chart is presented depicting the present technique of improving perceived digital image quality. Initially, an input image 32 acquired by the digital imaging circuitry 12 is received by image processing circuitry 14 where it is rescaled using interpolation, as is depicted in block 34. Interpolation is typically bilinear or bicubic, but may be based upon any other algorithm as is practiced in the art. Rescaling produces an interpolated image 38 which may be further processed. In an embodiment typical of digital X-ray in the field of medical imaging, a digital input image 32 may have a pixel pitch on the order of 200 μm and will be rescaled by the processes depicted in block 32 to produce an interpolated image 38 with a pixel pitch on the order of 86 μm, i.e., the effective pixel pitch of an analog image.

In addition to producing the interpolated image 38, information from the rescaling processes depicted in block 34 is used to determine a weighting factor for each pixel of the interpolated image as depicted by block 40. The determination of a pixel weighting factor, as depicted in block 40, is typically a function of intensity, such as the actual or squared intensity or the contrast based upon the surrounding pixels, but may also be a function of other pixel traits such as color. The determination of pixel weighting 40 is typically accomplished by looking up the appropriate weighting factor in a weighting table 42 which typically provides different pixel weighting factors based upon pixel intensity. The weighting table 42 may be a fixed table or may be produced by iteratively sampling, decisions and adjustments made by the operator, i.e., a trial and error approach, such that the weighting table 42 reflects the preferences of the operator.

The pixel weighting factors determined in block 40 are then applied to random numbers generated by processes depicted in block 44. Random numbers are typically generated using a random number generator, as is known in the art, which may be incorporated into image processor 14 or an associated component. The random numbers may be generated as needed or generated in advance and stored for further processing. The generated random numbers constitute “noise” to be added to the interpolated image 38 and may be generated by various functions to produce different distributions of random numbers including, but not limited to, normal, uniform, tukey, logistical, binomial, and Poisson distributions. The distribution of random numbers may be filtered such that the addition of noise to the interpolated image 38 is selective. In particular, a high-pass spatial filter may be applied to the random number distribution to selectively add noise frequencies around and below the nyquist frequency, i.e. pixel pitch, of the input data.

The random numbers generated in block 44, whether filtered or unfiltered, are then weighted by the individual pixel weightings determined in block 40 to form a weighted noise image or mask 46. Since the pixel weightings determined in block 40 are typically intensity based, the weighted noise image 46 is generally an intensity dependent noise image.

The weighted noise image 46 is then combined with the interpolated image 38 as depicted in block 48. In one embodiment, the respective pixel intensity values of the weighted noise image 46 and the interpolated image 38 are simply additively combined on a pixel-by-pixel basis by the processes of block 48. Other combinatorial methods are possible however, such as log-based addition, additional weighting or manipulation of one of the images, or by constructing the weighted noise image 46 such that it may be multiplicatively combined with the interpolated image 38. The combinatorial processes depicted in block 48 yield an output image 40 which may then be relayed from the image processing circuitry 14 to the display circuitry 16 or to the memory circuitry 22.

In a typical embodiment, the effect of the combinatorial process depicted in block 48 is to add fractional amounts of intensity-dependent, uniform noise to the interpolated image 38, thereby introducing high frequencies to the image which would be otherwise absent. In alternate embodiments, however, the weighting need not be intensity-based, nor must the noise be uniform. Once the high frequencies have been introduced to the interpolated image 38 in this manner, the noise grain of the interpolated image 38 is equivalent to that found in analog images, thereby creating the illusion of an analog noise texture to the image 38. The output image 50 is thereby improved such that operators trained on analog systems perceive the quality of the output image 50 to be as good as the quality of an analog image.

Further, while the benefits of the present technique are most clear with respect to a rescaled image, such as interpolated image 38, the technique may also be applied to a raw digital image, i.e., one which has not been rescaled, where there is a desire to improve the perceived image quality. For example, the addition of weighted noise to the interpolated image has the additional effect of masking compression artifacts associated with storage or transmission of a digital image so that such artifacts are less apparent.

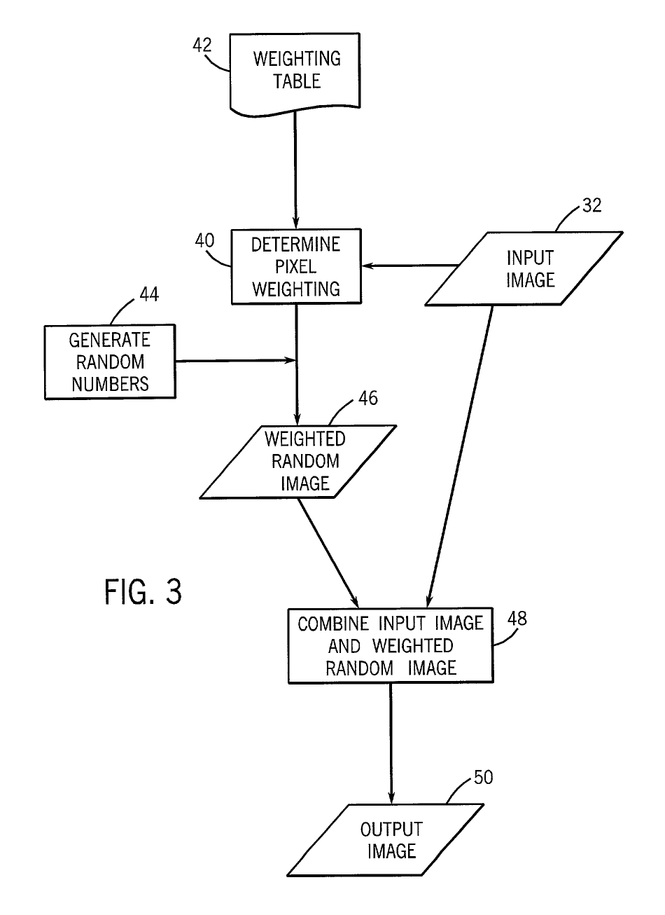

Referring now to FIG. 3, an example of the use of the above techniques on the raw input image 32 is depicted. In such a case, the weighting determined in block 40 is derived from the input image 32 and the combination which occurs in block 48 combines the weighted noise image 46 with the input image 32. A digital image to which the above techniques are applied may therefore be either a rescaled, interpolated image 38 or a raw, input image 32, as the circumstances require.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for improving the appearance of a digital image comprising:
constructing a weighted noise image of the same dimension as the digital image wherein the weighted noise image comprises a plurality of pixels such that each pixel is the product of a weighting factor and a random number; and
combining the weighted noise image and the digital image.

2. The method of claim 1, wherein the weighting factor is determined by a characteristic of a respective pixel of the digital image.

3. The method of claim 2, wherein the characteristic is intensity.

4. The method of claim 3, wherein the random number is drawn from a uniformly distributed population of numbers.

5. The method of claim 1, wherein the random number is drawn from a uniformly distributed population of numbers.

6. The method of claim 1, wherein the weighting factor is derived from a weighting table.

7. The method of claim 6, wherein the weighting table is constructed based upon prior operator experience.

8. The method of claim 1, wherein the weighted noise image and the digital image are combined by adding the weighted noise image to the digital image.

9. The method of claim 1, further comprising displaying an output image resulting from combining the weighted noise image and the digital image.

10. The method of claim 9, wherein the addition is log-based.

11. The method of claim 1, further comprising storing an output image produced by combining the weighted noise image and the digital image.

12. The method of claim 1, wherein the random number is drawn from a filtered distribution of random numbers.

13. The method of claim 12, wherein the distribution of random numbers is filtered with a high-pass spatial filter.

14. A method for improving the appearance of a digital image comprising:
constructing an intensity dependent noise image of the same dimension as the digital image wherein the intensity dependent noise image comprises a plurality of pixels such that each pixel is the product of an intensity dependent weighting factor, determined by a respective pixel of the digital image, and a random number drawn from a uniformly distributed population of numbers; and
combining the intensity dependent noise image and the digital image.

15. The method of claim 14, wherein the weighting factor is derived from a weighting table.

16. The method of claim 15, wherein the weighting table is constructed based upon prior operator experience.

17. The method of claim 14, wherein the intensity dependent noise image and the digital image are combined by adding the intensity dependent noise image to the digital image.

18. The method of claim 17, wherein the addition is log-based.

19. The method of claim 14, further comprising displaying an output image produced by combining the intensity dependent noise image and the digital image.

20. The method of claim 14, further comprising storing an output image produced by combining the intensity dependent noise image and the digital image.

21. The method of claim 14, wherein the uniformly distributed population of numbers is filtered.

22. The method of claim 21, wherein the uniformly distributed population of numbers is filtered by a high-pass spatial filter.

23. An image processing system comprising:
a digital imaging circuitry capable of generating a digital image; and
an image processing circuitry capable of receiving the digital image, resealing the digital image to form a rescaled image comprising a plurality of pixels, generating a weighted noise image based upon one or more characteristics of each pixel of the plurality of pixels and upon a series of random numbers, and combining the weighted noise image and the rescaled image to form an output image.

24. The image processing system of claim 23, wherein the image processing circuitry rescales the digital image using an interpolation technique.

25. The image processing system of claim 23, wherein the one or more characteristics of each pixel of the plurality of pixels is intensity.

26. The image processing system of claim 25, wherein the series of random numbers is uniformly distributed.

27. The image processing system of claim 26, wherein the image processing circuitry generates the weighted noise image comprising a second plurality of pixels by multiplying a weighting factor determined by the intensity of each pixel of the plurality of pixels and a random number from the series of random numbers.

28. The image processing system of claim 23, wherein the series of random numbers is uniformly distributed.

29. The image processing system of claim 23, wherein combining the weighted noise image and the rescaled image comprises adding the weighted noise image to the rescaled image.

30. The image processing system of claim 29, wherein the addition is log-based.

31. The image processing system of claim 23, further comprising a display circuitry capable of receiving the output image and displaying the output image on a monitor.

32. The image processing system of claim 23, further comprising a display circuitry capable of receiving the output image and printing the output image on a printer.

33. The image processing system of claim 23, further comprising a memory circuitry capable of receiving and storing the output image.

34. The image processing system of claim 23, wherein the series of random numbers is filtered.

35. The image processing system of claim 34, wherein the series of random numbers is filtered with a high-pass spatial filter.

36. An image processing system comprising:
a digital imaging circuitry capable of generating a digital image; and
an image processing circuitry capable of receiving the digital image, resealing the digital image to form a rescaled image comprising a plurality of pixels, generating an intensity dependent noise image based upon the intensity of each pixel of the plurality of pixels and upon a uniformly distributed series of random numbers, and combining the intensity dependent noise image and the rescaled image to form an output image.

37. The image processing system of claim 36, wherein the image processing circuitry rescale the digital image using an interpolation technique.

38. The image processing system of claim 36, wherein the image processing circuitry generates the intensity dependent noise image comprising a second plurality of pixels by multiplying a weighting factor determined by the intensity of each pixel of the plurality of pixels and a random number from the series of random numbers.

39. The image processing system of claim 36, wherein combining the intensity dependent noise image and the rescaled image comprises adding the intensity dependent noise image to the rescaled image.

40. The image processing system of claim 39, wherein addition is log-based.

41. The image processing system of claim 36, further comprising a display circuitry capable of receiving the output image and displaying the output image on a monitor.

42. The image processing system of claim 36, further comprising a display circuitry capable of receiving the output image and printing the output image on a printer.

43. The image processing system of claim 36, further comprising a memory circuitry capable of receiving and storing the output image.

44. The image processing system of claim 36, wherein the uniformly distributed series of random numbers is filtered.

45. The image processing system of claim 44, wherein the uniformly distributed series of random numbers is filtered with a high-pass spatial filter.

46. An image processing circuit capable of receiving a digital image, the image processing circuit comprising:
one or more circuits which generate a weighted noise image of the same dimensions as the digital image and comprising a plurality of pixels such that the value of each pixel is the product of a weighting factor and a random number and which combine the weighted noise image and the digital image.

47. The image processing circuit of claim 46, wherein the weighting factor is determined by a characteristic of a respective pixel of the digital image.

48. The image processing circuit of claim 47, wherein the characteristic is intensity.

49. The image processing circuit of claim 46, wherein the random number is drawn from a uniformly distributed population of random numbers.

50. The image processing circuit of claim 46, wherein the weighted noise image and the digital image are combined by adding the weighted noise image to the digital image.

51. The image processing circuit of claim 46, wherein the weighted noise image and the digital image are combined by log-based addition of the weighted noise image and of the digital image.

52. The image processing circuit of claim 46, wherein the random number is derived from a filtered distribution of random numbers.

53. The image processing circuit of claim 52, wherein the distribution of random numbers is filtered by a high-pass spatial filter.

54. An image processing circuit capable of receiving a digital image, the image processing circuit comprising:
one or more circuits which generate an intensity dependent noise image of the same dimension as the digital image and comprising a plurality of pixels such that each pixel is the product of a weighting factor determined by the intensity of a respective pixel of the digital image and a random number from a uniformly distributed population of random numbers and which combine the intensity dependent noise image and the digital image.

55. The image processing circuit of claim 54, wherein the weighted noise image and the digital image are combined by adding the intensity dependent noise image to the digital image.

56. The image processing circuit of claim 54, wherein the intensity dependent noise image and the digital image are combined by log-based addition of the intensity dependent noise image and of the digital image.

57. The image processing circuit of claim 54, wherein the uniformly distributed population of random numbers is filtered.

58. The image processing circuit of claim 57, wherein the uniformly distributed population of random numbers is filtered by a high-pass spatial filter.

59. An image processing system comprising:
a digital imaging circuitry capable of generating a digital image; and
an image processing circuitry capable of resealing the digital image to form a rescaled image and of combining the rescaled image and a weighted noise image to form an output image, the image processing circuitry comprising a means for generating the weighted noise image;

60. The image processing system of claim 59, wherein combining the weighted noise image and the rescaled image comprises adding the weighted noise image to the rescaled image.

61. The image processing system of claim 59, wherein combining the weighted noise image and the resealed image comprises the log-based addition of the weighted noise image and of the rescaled image.

62. The image processing system of claim 59, wherein the image processing circuitry rescales the digital image using an interpolation technique.

63. The image processing system of claim 59, further comprising a display circuitry capable of receiving the output image and displaying the output image on a monitor.

64. The image processing system of claim 59, further comprising a display circuitry capable of receiving the output image and printing the output image on a printer.

65. The image processing system of claim 59, further comprising a memory circuitry capable of receiving and storing the output image.

66. An image processing circuit capable of receiving a digital image, the image processing circuit comprising:
a means for generating a weighted noise image; and
one or more circuits for combining the weighted noise image and the digital image.

67. The image processing circuit of claim 66, wherein the weighted noise image and the digital image are combined by adding the weighted noise image to the digital image.

68. The image processing system of claim 66, wherein combining the weighted noise image and the digital image comprises the log-based addition of the weighted noise image and of the digital image.
